(19) United States
(12) Patent Application Publication
(10) Pub. No.: US 2008/0198125 A1
(43) Pub. Date: Aug. 21, 2008

(54) CIRCUIT BOARD AND LIQUID CRYSTAL DISPLAY INCLUDING THE SAME

(75) Inventors: Joo-hwan Park, Suwon-si (KR); Chung-hyuk Shin, Suwon-si (KR); Seung-hoon Jung, Asan-si (KR)

Correspondence Address: CANTOR COLBURN, LLP, 20 Church Street, 22nd Floor, Hartford, CT, 06103, US

(73) Assignee: SAMSUNG ELECTRONCS CO., LTD., Suwon-si (KR)

(21) Appl. No.: 11/856,940

(22) Filed: Sep. 18, 2007

(30) Foreign Application Priority Data
Feb. 20, 2007 (KR) 10-2007-0017109

(51) Int. Cl. G09G 3/36

(52) U.S. Cl. 345/98

(57) ABSTRACT

A circuit board includes; a reference common voltage generating circuit receiving an input voltage from an input node and outputting a reference common voltage to an output node, wherein the reference common voltage generating circuit includes a voltage distribution unit including a first resistor connected between the input node and the output node and a second resistor connected between the output node and a ground, and a sink current generating unit outputting a sink current to the output node, wherein the sink current is adjusted according to a resistance of a setting resistor, and a coupling line coupling the setting resistor and the reference common voltage generating circuit.

This application claims priority to Korean Patent Application No. 10-2007-0017109, filed on Feb. 20, 2007, and all the benefits accruing therefrom under 35 U.S.C. § 119, the contents of which in its entirety are herein incorporated by reference.

### BACKGROUND OF THE INVENTION

1. Field of the Invention

The present invention relates to a circuit board and a liquid crystal display including the same.

2. Description of the Related Art

Liquid crystal displays (“LCDs”) include a liquid crystal panel including a first display panel wherein pixel electrodes are formed, a second display panel wherein a common electrode is formed, and a liquid crystal layer interposed between the first display panel and the second display panel. An image data voltage is applied to the pixel electrodes and a common voltage is applied to the common electrode. The orientation of liquid crystal molecules can be controlled according to a potential difference between the data voltage supplied to the pixel electrodes and the common voltage supplied to the common electrode. The polarization of light passing through the liquid crystal layer may be varied by the orientation of the liquid crystal molecules. LCDs utilize the controllable orientation of liquid crystal molecules to vary the transmittance of light through the display. LCDs may include a plurality of pixels, wherein the transmittance of light in each pixel may be independently controlled to display images. An LCD may display moving images by rapidly displaying a succession of slightly varying images, each image is referred to as a frame, which the observer then interprets as motion.

In order to prolong the lifetime of an LCD display, the polarization of the image data voltage may vary about the common voltage from one frame to the next. This prevents the liquid crystal molecules from prematurely wearing out and losing their ability to vary the transmittance of light through the liquid crystal layer. However, an unwanted flicker phenomenon may develop due to an uneven voltage difference about the common electrode from one frame to the next. One way of minimizing flicker is to precisely control the common voltage applied to the common electrode.

LCDs also include circuit boards on which circuits for driving liquid crystal panels are mounted, e.g., a control circuit board on which a timing controller, a common voltage generating circuit, a grayscale voltage generating circuit, etc. are mounted; a source circuit board including circuits coupled to a data driver to operate the data driver and lines for supplying signals output from the timing controller to the data driver; and a flexible circuit board coupling the control circuit board and the source circuit board. In particular, the common voltage generating circuit mounted on the control circuit board may have a different size, resistor component, and capacitor component according to the type of liquid crystal panel being driven. Thus, in order to minimize flicker of a liquid crystal panel, the common voltage generating circuit is structured to generate a plurality of common voltages optimized for each liquid crystal panel.

According to such a conventional technique, control circuit boards on which common voltage generating circuits are mounted must be respectively manufactured for each different model of liquid crystal panel, thereby increasing manufacturing costs of the LCDs.

### BRIEF SUMMARY OF THE INVENTION

The present invention provides a circuit board capable of reducing manufacturing costs.

The present invention also provides a liquid crystal display (“LCD”) with reduced manufacturing costs.

These and other aspects of the present invention will be described in or be apparent from the following description of the exemplary embodiments.

According to an exemplary embodiment of the present invention a circuit board includes; a reference common voltage generating circuit receiving an input voltage from an input node and outputting a reference common voltage to an output node, wherein the reference common voltage generating circuit includes; a voltage distribution unit including a first resistor connected between the input node and the output node and a second resistor connected between the output node and a ground, and a sink current generating unit outputting a sink current to the output node, wherein the sink current is adjusted according to a resistance of a setting resistor, and a coupling line coupling the setting resistor and the reference common voltage generating circuit.

According to another exemplary embodiment of the present invention, an LCD includes; a first circuit board including a reference common voltage generating circuit which outputs a reference common voltage, wherein the reference common voltage generating circuit is coupled to a setting resistor via a coupling line, a second circuit board including an individual common voltage generating circuit receiving the reference common voltage and outputting a plurality of individual common voltages, and a liquid crystal panel coupled to the second circuit board to receive the individual common voltages.

According to still another exemplary embodiment of the present invention, an LCD includes; a first circuit board including a timing controller outputting an image signal, a data control signal, and a gate control signal, and a reference common voltage generating circuit outputting a reference common voltage, a second circuit board including an individual common voltage generating circuit receiving the reference common voltage and outputting a plurality of individual common voltages, and signal lines transmitting the image signal, the data control signal, and the gate control signal, a data driver outputting an image data voltage corresponding to the image signal in response to the data control signal supplied from the second circuit board, a gate driver outputting a gate signal in response to the gate control signal supplied from the second circuit board, and a liquid crystal panel coupled to the data driver and the gate driver, the liquid crystal panel including a first display panel including a plurality of gate lines receiving the gate signal, a plurality of data lines receiving the image data voltage, and a plurality of pixel electrodes connected to the gate lines and the data lines, a second display panel including a common electrode disposed substantially opposite the pixel electrodes, and a liquid crystal layer interposed between the first display panel and the second display panel.

According to still another exemplary embodiment of the present invention, a method of manufacturing an LCD includes; providing a first circuit board including a reference common voltage generating circuit, coupling the reference common voltage generating circuit to a setting resistor, providing a second circuit board including an individual common voltage generating circuit, wherein the individual common voltage generating circuit receives a reference common voltage from the reference common voltage generating circuit, and coupling the second circuit board to a liquid crystal panel, wherein the liquid crystal panel receives individual common voltages output from the common voltage generating circuit.

### BRIEF DESCRIPTION OF THE DRAWINGS

The above and other features and advantages of the present invention will become more apparent by describing in detail exemplary embodiments thereof with reference to the attached drawings in which:

FIG. 1A is an exploded perspective view illustrating an exemplary embodiment of a circuit board and an exemplary embodiment of a liquid crystal display (“LCD”) including the circuit board according to the present invention;

FIG. 1B is a bottom perspective view illustrating an exemplary embodiment of an LCD according to the present invention;

FIG. 2 is a block diagram illustrating an exemplary embodiment of a circuit board and an exemplary embodiment of an LCD including the circuit board according to the present invention;

FIG. 3 is an equivalent circuit schematic diagram of an exemplary embodiment of a pixel of the exemplary embodiment of an LCD of FIG. 2;

FIG. 4 is an equivalent circuit schematic diagram illustrating an exemplary embodiment of a circuit board of an exemplary embodiment of an LCD including the circuit board according to the present invention;

FIG. 5 is an equivalent circuit schematic diagram illustrating an exemplary embodiment of an individual common voltage generating circuit of FIG. 4; and

FIG. 6 is an equivalent circuit schematic diagram illustrating an exemplary embodiment of a circuit board of an exemplary embodiment of an LCD including the circuit board according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

Hereinafter, an exemplary embodiment of a circuit board according to the present invention will also be described as a “first circuit board” in order to distinguish it from a flexible circuit board and a second circuit board of a liquid crystal display (“LCD”).

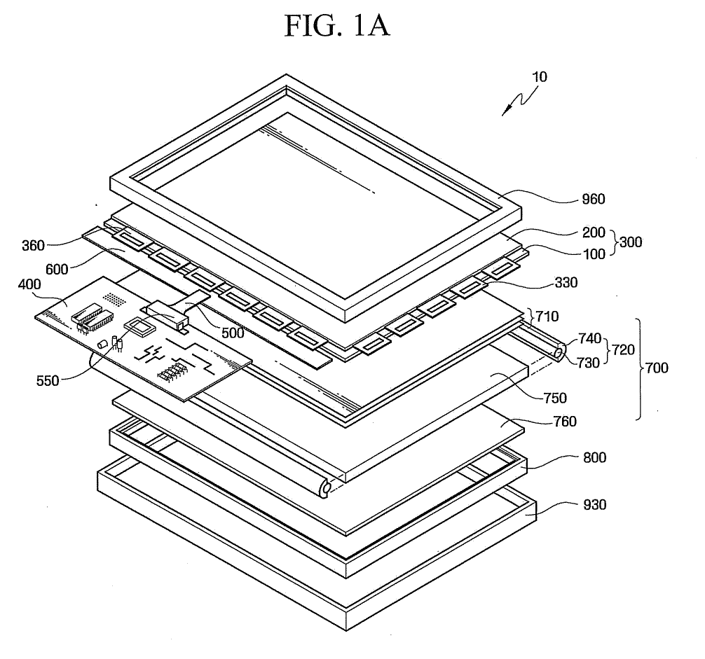

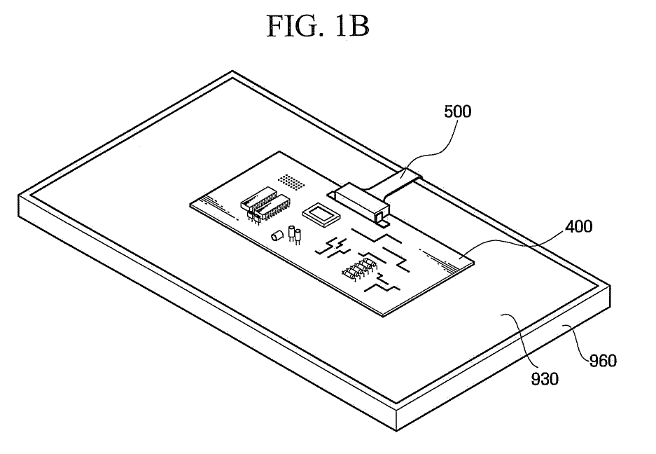

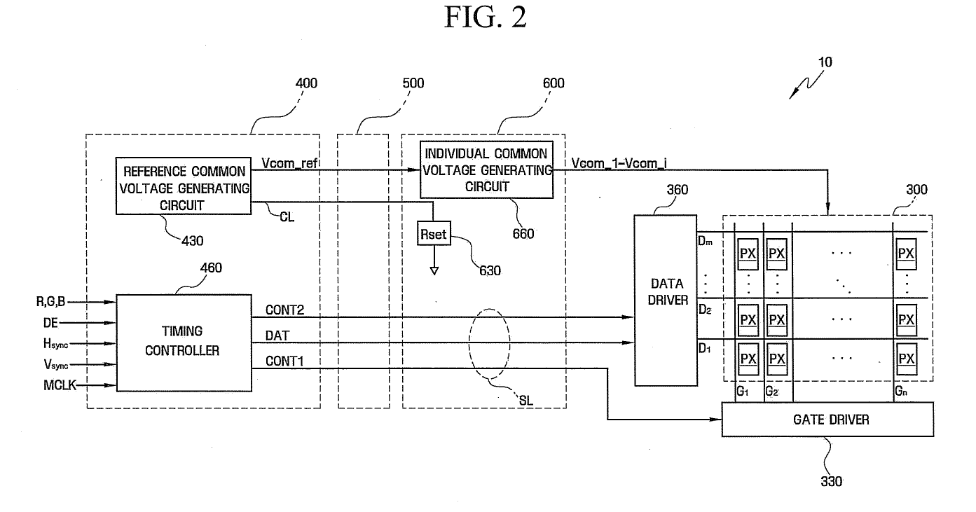

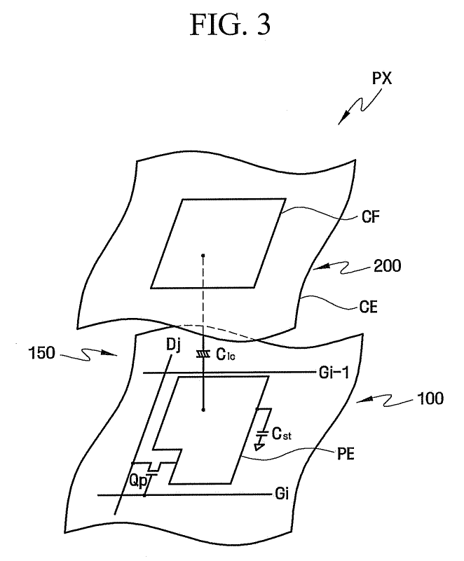

FIG. 1A is an exploded perspective view illustrating an exemplary embodiment of a circuit board and an exemplary embodiment of an LCD including the circuit board according to the present invention, FIG. 1B is a bottom perspective view illustrating an exemplary embodiment of an LCD according to the present invention, FIG. 2 is a block diagram illustrating an exemplary embodiment of a circuit board and an exemplary embodiment of an LCD including the circuit board according to the present invention, and FIG. 3 is an equivalent circuit schematic diagram of an exemplary embodiment of a pixel of the exemplary embodiment of an LCD of FIG. 2.

Referring to FIGS. 1A through 3, an exemplary embodiment of an LCD 10 according to the present invention includes a liquid crystal panel 300, a gate driver 330, a data driver 360, a first circuit board 400, a flexible circuit board 500, a second circuit board 600, a backlight assembly 700, a mold frame 800, a lower housing 930, and an upper housing 960. While the circuit board 400 is illustrated in FIGS. 1-3 with various circuitry elements thereon, theses features are included for illustrative purposes only, especially the orientation of various surfaces of the circuit board 400, and the invention is not limited to the elements shown.

First, as shown in FIGS. 2 and 3, the liquid crystal panel 300 includes a plurality of display signal lines G1-Gn and D1-Dm and a plurality of pixels PX which are connected to the display signal lines G1-Gn and D1-Dm at intersections between the display signal lines G1-Gn and D1-Dm and are arranged in a matrix shape. The display signal lines G1-Gn include a plurality of gate lines for gate signal transmission and the display signal lines D1-Dm include a plurality of data lines for data signal transmission. In the present exemplary embodiment the gate lines G1-Gn are roughly arranged in columns and are substantially parallel to each other, and the data lines D1-Dm are roughly arranged in rows and are substantially parallel to each other. Alternative exemplary embodiments include configurations wherein the orientation of the gate lines and data lines differ.

Here, referring to FIG. 3, each pixel PX of the liquid crystal panel 300 (e.g., a pixel PX connected to an i-th gate line Gi and a j-th data line Dj) includes first and second display panels 100 and 200 facing each other and a liquid crystal layer 150 interposed therebetween. The first display panel 100 includes a switching device Qp and a pixel electrode PE, and the second display panel 200 includes a common electrode CE and a color filter CF facing the pixel electrode PE. A liquid crystal capacitor Clc consists of the pixel electrode PE, the common electrode CE, and the liquid crystal layer 150 interposed therebetween. The pixel PX according to the present exemplary embodiment further includes a storage capacitor Cst. Alternative exemplary embodiments include configurations wherein the storage capacitor Cst is omitted.

The gate driver 330 is coupled to the gate lines G1-Gn to supply gate signals thereto. The gate driver 330 is controlled by a gate control signal CONT1 supplied from a timing controller 460. The gate control signal CONT1 is output from the timing controller 460 mounted on the first circuit board 400, and then transmitted to the gate driver 330 via the flexible circuit board 500 and the second circuit board 600.

Here, the gate control signal CONT1 is a signal for controlling the operation of the gate driver 330 and exemplary embodiments thereof may include a vertical scanning start signal for initializing the start of the operation of the gate driver 330, gate clock signals for controlling output time of a gate-ON voltage, and an output enable signal for defining the pulse width of the gate-ON voltage.

Although not shown, exemplary embodiments include configurations wherein the gate driver 330 may receive a gate on/off voltage from a gate on/off voltage generating circuit mounted on the first circuit board 400.

The data driver 360 is coupled to the data lines D1-Dm to supply image data voltages thereto. That is, the data driver 360 supplies image data voltages corresponding to an image signal DAT to the data lines D1-Dm in response to a data control signal CONT2 output from the timing controller 460. The data control signal CONT2 and the image signal DAT are output from the timing controller 460 mounted on the first circuit board 400 and then transmitted to the data driver 360 via the flexible circuit board 500 and the second circuit board 600.

Here, the data control signal CONT2 is a signal for controlling the operation of the data driver 360 and exemplary embodiments thereof may include a horizontal scanning start signal for initializing the start of the operation of the data driver 360, and an output instruction signal for instructing the output of image data voltages.

In addition, although not shown, exemplary embodiments include configurations wherein the data driver 360 may receive a plurality of grayscale voltages from a grayscale voltage generating circuit mounted on the first circuit board 400. The data driver 360 selects image data voltages corresponding to the image signal DAT from the plurality of grayscale voltages and supplies the selected data voltages to the data lines D1-Dm.

Meanwhile, the timing controller 460 and a reference common voltage generating circuit 430 are mounted on the first circuit board 400. The timing controller 460 receives red (R), green (G), and blue (B) signals, and control signals Vsync, Hsync, MCLK, and DE for controlling the display of the R, G, and B signals from a graphic controller (not shown). Alternative exemplary embodiments include configurations wherein the timing controller may receive other color signals besides red, green and blue. The timing controller 460 generates the gate control signal CONT1 and the data control signal CONT2 based on the control signals Vsync, Hsync, MCLK, and DE, and the image signal DAT based on the R, G, and B signals.

The reference common voltage generating circuit 430 generates a reference common voltage Vcom_ref and supplies the reference common voltage Vcom_ref to an individual common voltage generating circuit 660. The reference common voltage generating circuit 430 is coupled to a setting resistor 630 mounted on the second circuit board 600, and outputs the reference common voltage Vcom_ref, which varies according to the resistance of the setting resistor 630. The first circuit board 400 further includes a coupling line CL for coupling the reference common voltage generating circuit 430 and the setting resistor 630.

The flexible circuit board 500 couples the first circuit board 400 and the second circuit board 600 together, and transmits the reference common voltage Vcom_ref, the gate control signal CONT1, the data control signal CONT2, and the image signal DAT, which are generated in the first circuit board 400, to the second circuit board 600. Exemplary embodiments include configurations wherein the flexible circuit board 500 is connected to the first circuit board 400 via a connector 550.

In the present exemplary embodiment the second circuit board 600 includes the individual common voltage generating circuit 660, the setting resistor 630, and signal lines SL. Alternative exemplary embodiments include configurations wherein the individual common voltage generating circuit 660 or the setting resistor 630 are mounted on various other circuit boards, e.g., the first circuit board 400 or the flexible circuit board 500.

The signal lines SL transmit the gate control signal CONT1, the data control signal CONT2, and the image signal DAT generated from the timing controller 460 to the gate driver 330 and the data driver 360.

The individual common voltage generating circuit 660 receives the reference common voltage Vcom_ref and generates a plurality of individual common voltages Vcom_1-Vcom_i, wherein i is an integer greater than 1. Here, the individual common voltages Vcom_1-Vcom_i are voltages capable of minimizing flicker of the liquid crystal panel according to the characteristics of the liquid crystal panel 300 and are applied to the common electrode CE of the liquid crystal panel 300. The internal structure of the individual common voltage generating circuit 660 will be described later by way of illustrative embodiments.

The setting resistor 630 is coupled to the reference common voltage generating circuit 430 to optimize the reference common voltage Vcom_ref according to the characteristics of the liquid crystal panel 300. For example, assuming that the reference common voltage Vcom_ref is 6.318V for a 40-inch liquid crystal panel and 6.437V for a 46-inch liquid crystal panel, the resistance of the setting resistor 630 is adjusted, in order to minimize flicker of the liquid crystal panel, and the reference common voltage Vcom_ref is adjusted according to the resistance of the setting resistor 630 such that when the liquid crystal panel 300 is a 40-inch liquid crystal panel, the reference common voltage Vcom_ref is 6.318V, and when the liquid crystal panel 300 is a 46-inch liquid crystal panel, the reference common voltage Vcom_ref is 6.437V. Exemplary embodiments include configurations wherein the setting resistor 630 is a single resistance device or a digital variable resistor.

That is, the reference common voltage Vcom_ref is adjusted according to the resistance of the setting resistor 630 mounted on the second circuit board 600 so that it is suitable for the characteristics of the liquid crystal panel 300, and thereby flicker is reduced. Thus, the first circuit board 400 on which the reference common voltage generating circuit 430 is mounted can be applied to any LCD regardless of the characteristics of the liquid crystal panel 300. Thus, it is possible to standardize and mass-produce the first circuit board 400, and to reduce the manufacturing costs of the first circuit board 400 and the LCD 10.

Meanwhile, exemplary embodiments of the backlight assembly 700 may include a light source unit 720, a light guide plate 750, a reflective sheet 760, and optical sheets 710.

In the present exemplary embodiment the light source unit 720 is disposed on at least one side of the light guide plate 750, and may include a light source 730 and a light source cover 740 covering the light source 730. Alternative exemplary embodiments include configurations wherein the light source unit 720 includes a plurality of light sources 730 disposed beneath the light guide plate 750 with respect to the liquid crystal panel 300. In the present exemplary embodiment the light guide plate 750 has a rectangular shape, and serves to guide light emitted from the light source unit 720 toward the liquid crystal panel 300. Alternative exemplary embodiments include configurations wherein the light guide plate 750 is variously configured to direct light to the liquid crystal panel 300. The reflective sheet 760 may be disposed below the light guide plate 750. The reflective sheet 760 reflects light leaked from a lower surface of the light guide plate 750 toward the light guide plate 750 in order to increase brightness of the LCD 10. The optical sheets 710 may be disposed on the light guide plate 750. The optical sheets 710 uniformly direct the light guided through the light guide plate 750 toward the upper part of the backlight assembly 700. Alternative exemplary embodiments include configurations wherein one or more of the abovementioned components of the backlight assembly 700 are omitted or variously modified.

The mold frame 800 has therein a predetermined receiving space to receive the above-described backlight assembly 700.

The lower housing 930 may be disposed below the backlight assembly 700 to receive and support the liquid crystal panel 300, the backlight assembly 700, and the mold frame 800. The second circuit board 600 is also received in the lower housing 930. The flexible circuit board 500 may be folded toward a rear surface of the lower housing 930 as shown in FIG. 1B, and thus the first circuit board 400 may be disposed on the rear surface of the lower housing 930. The upper housing 960 is combined with the lower housing 930 to complete the assembled LCD 10.

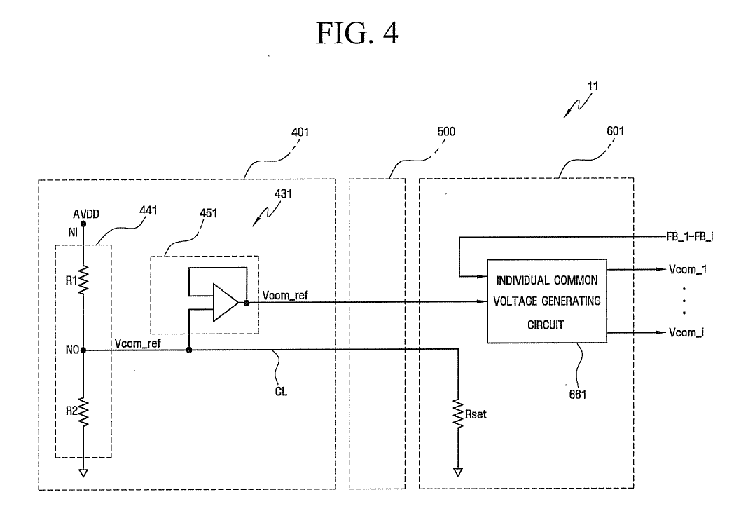

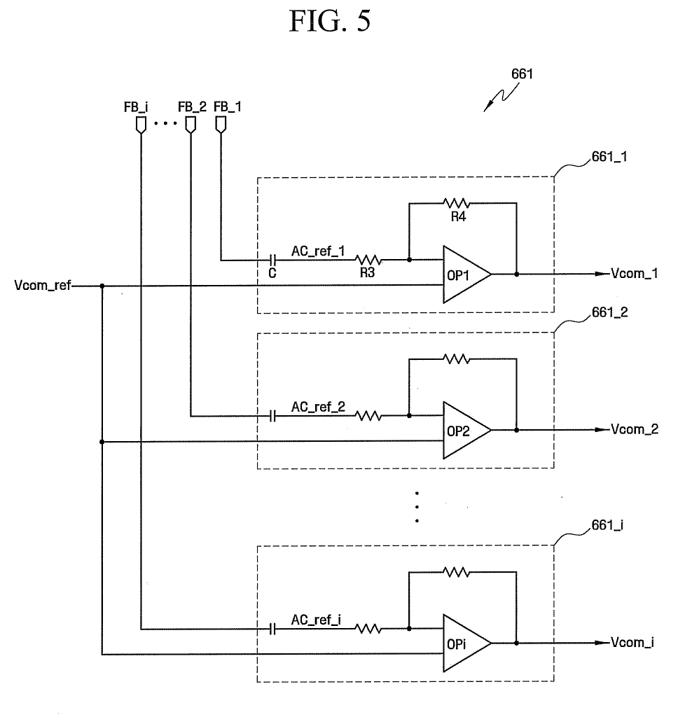

Hereinafter, an exemplary embodiment of a circuit board and an exemplary embodiment of an LCD including the circuit board according to the present invention will be described with reference to FIGS. 4 and 5.

FIG. 4 is an equivalent circuit schematic diagram illustrating an exemplary embodiment of a circuit board of an exemplary embodiment of an LCD including the circuit board according to the present invention, and FIG. 5 is an equivalent circuit schematic diagram illustrating an exemplary embodiment of an individual common voltage generating circuit of FIG. 4. For brevity, components each having the same function as the components described in the exemplary embodiments shown in FIG. 2 are respectively identified by the same reference numerals, and their repetitive description will be omitted.

First, referring to FIG. 4, an exemplary embodiment of an LCD 11 according to the present invention includes a first circuit board 401. The first circuit board 401 includes a reference common voltage generating circuit 431 coupled to a setting resistor Rset. The first circuit board 401 generates a reference common voltage Vcom_ref which varies according to the resistance of the setting resistor Rset and a coupling line CL coupling the setting resistor Rset and the reference common voltage generating circuit 431.

In more detail, the reference common voltage generating circuit 431 includes a voltage distribution unit 441 and a buffer unit 451.

The voltage distribution unit 441 receives an input voltage AVDD from an input node NI and outputs the reference common voltage Vcom_ref from an output node NO. The voltage distribution unit 441 includes a first resistor R1 connected between the input node NI and the output node NO and a second resistor R2 connected between the output node NO and a ground voltage. Although the present exemplary embodiment is described with reference to a ground voltage, any number or alternative reference voltages may be applied. Here, the setting resistor Rset mounted on a second circuit board 601 is connected in parallel to the second resistor R2. That is, the voltage distribution unit 441 distributes the input voltage AVDD according to the ratio of the resultant resistance of the parallel-connected second resistor R2 and setting resistor Rset and the resistance of the first resistor R1. As a result the voltage distribution unit 441 outputs the reference common voltage Vcom_ref. As described above, the setting resistor Rset can be selected to have a different resistance corresponding to a multitude of different liquid crystal panels with varying characteristics, and the resistance of the setting resistor Rset can be adjusted so that the reference common voltage Vcom_ref is optimized for minimizing flicker of the liquid crystal panel.

The buffer unit 451 constantly maintains the reference common voltage Vcom_ref and transmits the reference common voltage Vcom_ref to an individual common voltage generating circuit 661. In one exemplary embodiment the buffer unit 451 may include an operational amplifier.

The individual common voltage generating circuit 661 mounted on the second circuit board 601 receives the reference common voltage Vcom_ref and outputs a plurality of individual common voltages Vcom_1-Vcom_i. The individual common voltage generating circuit 661 receives a voltage fed back from a common electrode (see CE of FIG. 3) of a liquid crystal panel (see 300 of FIG. 2), and outputs the plurality of individual common voltages Vcom_1-Vcom_i according to the received voltage.

The individual common voltage generating circuit 661 will be described in more detail with reference to FIG. 5. Referring to FIG. 5, together with FIG. 4, the individual common voltage generating circuit 661 includes a plurality of individual common voltage generators 661_1-661_i, wherein i is an integer. The individual common voltage generators 661_1-661_i include capacitors C, operational amplifiers OP_1-OP_i, and a plurality of resistors R3 and R4.

Feed back voltages FB_1-FB_i taken from various parts of the common electrode CE are fed back to the individual common voltage generators 661_1-661_i. The capacitors C receive the feed back voltages FB_1-FB_i from the common electrode CE and output reference alternating voltages AC_ref_1-AC_ref_i which are alternating voltages. The operational amplifiers OP_1-OP_i receive and amplify the reference alternating voltages AC_ref_1-AC_ref_i and the reference common voltage Vcom_ref and output individual common voltages Vcom_1-Vcom_i. The individual common voltages Vcom_1-Vcom_i can be applied to the part of the common electrode where the feed back voltages FB_1-FB_i were originally taken from. The common voltages Vcom_1-Vcom_I are modified by the reference common voltage Vcom_ref, which in turn is modified by the setting resistor Rset, which in turn may be varied in order to reduce flicker. In the current exemplary embodiment, the resistances of the resistors R3 and R4 of the individual common voltage generators 661_1-661_i can be adjusted to generate individual common voltages Vcom_1-Vcom_i capable of minimizing flicker of the liquid crystal panel.

The above-described first circuit board 401 can be applied to any LCD regardless of the characteristics of a liquid crystal panel. Thus, it is possible to standardize and mass-produce the first circuit board 401, and to reduce the manufacturing costs of the first circuit board 401 and the LCD 11 including the first circuit board 401.

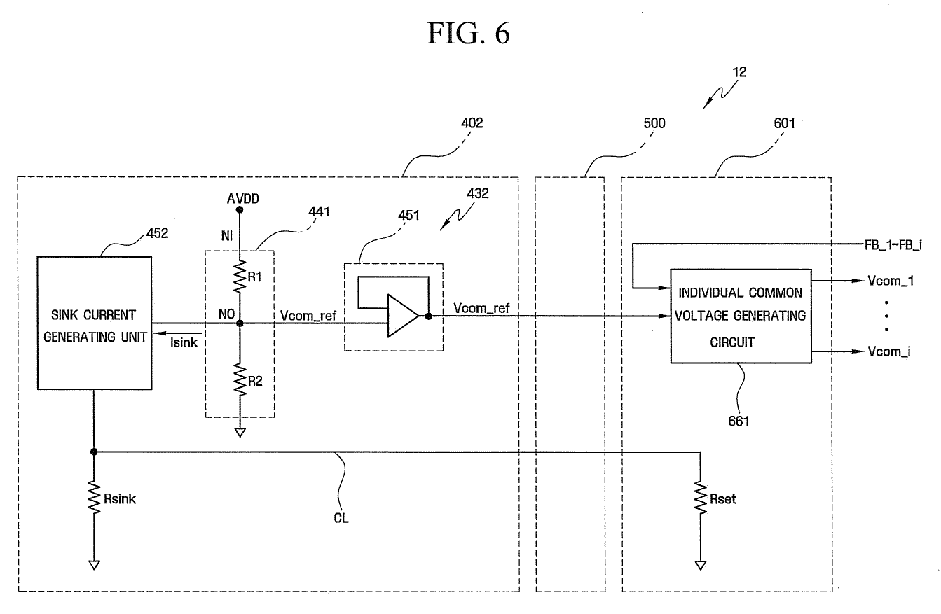

A circuit board and an LCD including the circuit board according to another embodiment of the present invention will be described with reference to FIG. 6.

FIG. 6 is an equivalent circuit schematic diagram illustrating an exemplary embodiment of a circuit board of another exemplary embodiment of an LCD according to the present invention. For brevity, components each having the same function as the described components in the embodiments shown in FIG. 4 are respectively identified by the same reference numerals, and their repetitive description will be omitted.

Referring to FIG. 6, an LCD 12 includes a first circuit board 402, and a reference common voltage generating circuit 432 of the first circuit board 402 further includes a sink current generating unit 452, unlike in the previous exemplary embodiment of the present invention.

The sink current generating unit 452 outputs a sink current Isink, which is adjusted according to the resistance of a setting resistor Rset, to an output node NO. In one exemplary embodiment the sink current generating unit 452 may be Model ISL45043 (Intersil™) or Model iML7971 (iML™). However, the present invention is not limited thereto, and the sink current generating unit 452 may be a known sink current generating circuit.

A reference common voltage Vcom_ref is obtained by distributing an input voltage AVDD through a first resistor R1 and a second resistor R2 and reducing the distributed voltage by a predetermined level through the sink current Isink. Here, the sink current Isink is adjusted by the resultant resistance of the setting resistor Rset and a sink resistor Rsink which are connected in parallel to each other. For example, as the resultant resistance of the setting resistor Rset and the sink resistor Rsink is increased, the sink current Isink is decreased. As the resultant resistance of the setting resistor Rset and the sink resistor Rsink is decreased, the sink current Isink is increased. The inner structure of sink current generating units and their output sink currents Isink are well known in the art, e.g., they are specifically described in the datasheets for ISL45043 or iML7971, and thus, a detailed description thereof will be omitted.

In summary, the reference common voltage Vcom_ref is adjusted according to the resistance of the setting resistor Rset mounted on a second circuit board 601, and thus, the first circuit board 402 can be applied to any LCD. Therefore, it is possible to standardize and mass-produce the first circuit board 402, and to reduce the manufacturing costs of the LCD 12.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

What is claimed is:

1. A liquid crystal display comprising:
a first circuit board comprising a reference common voltage generating circuit which outputs a reference common voltage, wherein the reference common voltage generating circuit is coupled to a setting resistor via a coupling line;
a second circuit board comprising an individual common voltage generating circuit receiving the reference common voltage and outputting a plurality of individual common voltages; and
a liquid crystal panel coupled to the second circuit board to receive the individual common voltages.

2. The liquid crystal display of claim 1, wherein the reference common voltage output by the reference common voltage generating circuit varies according to a resistance of the setting resistor.

3. The liquid crystal display of claim 2, wherein the reference common voltage generating circuit receives an input voltage from an input node and outputs the reference common voltage to an output node,
wherein the reference common voltage generating circuit comprises a first resistor connected between the input node and the output node and a second resistor connected between the output node and a ground, and
wherein the setting resistor is connected in parallel with the second resistor.

4. The liquid crystal display of claim 2, wherein the reference common voltage generating circuit receives an input voltage from an input node and outputs the reference common voltage to an output node, and
wherein the reference common voltage generating circuit comprises:
a voltage distribution unit comprising a first resistor connected between the input node and the output node and a second resistor connected between the output node and a ground; and
a sink current generating unit outputting a sink current, which is adjusted according to a resistance of the setting resistor, to the output node.

5. The liquid crystal display of claim 2, wherein the reference common voltage generating circuit further comprises a buffer unit maintaining the reference common voltage and transmitting the reference common voltage to the individual common voltage generating circuit.

6. The liquid crystal display of claim 1, further comprising a flexible circuit board coupling the first circuit board and the second circuit board.

7. The liquid crystal display of claim 1, wherein the setting resistor is disposed on the second circuit board.

8. A circuit board comprising:
a reference common voltage generating circuit receiving an input voltage from an input node and outputting a reference common voltage to an output node,
wherein the reference common voltage generating circuit comprises:
a voltage distribution unit comprising a first resistor connected between the input node and the output node and a second resistor connected between the output node and a ground; and
a sink current generating unit outputting a sink current to the output node, wherein the sink current is adjusted according to a resistance of an external setting resistor; and
a coupling line coupling the setting resistor and the reference common voltage generating circuit.

9. The circuit board of claim 8, wherein the reference common voltage generating circuit further comprises a buffer unit maintaining the reference common voltage and outputting the reference common voltage.

10. A liquid crystal display comprising:
a first circuit board comprising a timing controller outputting an image signal, a data control signal, and a gate control signal, and a reference common voltage generating circuit outputting a reference common voltage;
a second circuit board comprising an individual common voltage generating circuit receiving the reference common voltage and outputting a plurality of individual common voltages, and signal lines transmitting the image signal, the data control signal, and the gate control signal;
a data driver outputting an image data voltage corresponding to the image signal in response to the data control signal supplied from the second circuit board;
a gate driver outputting a gate signal in response to the gate control signal supplied from the second circuit board; and
a liquid crystal panel coupled to the data driver and the gate driver, the liquid crystal panel comprising a first display panel including a plurality of gate lines receiving the gate signal, a plurality of data lines receiving the image data voltage, and a plurality of pixel electrodes connected to the gate lines and the data lines, a second display panel including a common electrode disposed substantially opposite the pixel electrodes, and a liquid crystal layer interposed between the first display panel and the second display panel.

11. The liquid crystal display of claim 10, wherein the liquid crystal display further comprises a setting resistor coupled to the reference common voltage generating circuit, and the reference common voltage varies according to a resistance of the setting resistor.

12. The liquid crystal display of claim 11, wherein the first circuit board further comprises a coupling line coupling the setting resistor and the reference common voltage generating circuit.

13. The liquid crystal display of claim 11, wherein the reference common voltage generating circuit receives an input voltage from an input node and outputs the reference common voltage to an output node,
wherein the reference common voltage generating circuit comprises a first resistor connected between the input node and the output node and a second resistor connected between the output node and a ground, and
wherein the setting resistor is connected in parallel with the second resistor.

14. The liquid crystal display of claim 11, wherein the reference common voltage generating circuit receives an input voltage from an input node and outputs the reference common voltage to an output node, and
wherein the reference common voltage generating circuit comprises:
a voltage distribution unit comprising a first resistor connected between the input node and the output node and a second resistor connected between the output node and a ground; and
a sink current generating unit outputting a sink current, which is adjusted according to a resistance of the setting resistor, to the output node.

15. The liquid crystal display of claim 11, wherein the individual common voltage generating circuit comprises:
a capacitor receiving a voltage fed back from the common electrode and outputting a reference alternating voltage; and
an operational amplifier receiving the reference alternating voltage and the reference common voltage and outputting the individual common voltages.

16. The liquid crystal display of claim 11, wherein the reference common voltage generating circuit further comprises a buffer unit maintaining the reference common voltage and transmitting the reference common voltage to the individual common voltage generating circuit.

17. The liquid crystal display of claim 11, further comprising a flexible circuit board coupling the first circuit board and the second circuit board.

18. The liquid crystal display of claim 11, wherein the setting resistor is disposed on the second circuit board.
